(19) United States
(12) Patent Application Publication
(10) Pub. No.: US 2026/0269220 A1
(43) Pub. Date: Sep. 10, 2026

(54) CHARGED-STATE LITHIUM-ION BATTERIES CONSTRUCTED USING LITHIUM-FREE BINARY FE/MN-BASED CATHODE MATERIALS

(71) Applicant: Wayne State University, Detroit, MI (US)

(72) Inventors: Da Deng, Troy, MI (US); Venkata Rohit Punyapu, Dexter, MI (US)

(21) Appl. No.: 19/674,276

(22) Filed: May 12, 2026

Related U.S. Application Data
(62) Division of application No. 17/909,508, filed on Mar. 5, 2021, now Pat. No. 12,651,740.
(60) Provisional application No. 62/986,079, filed on Mar. 6, 2020.

(51) Int. Cl. H01M 4/36; H01M 4/02; H01M 4/1315; H01M 4/13915; H01M 4/38; H01M 4/50; H01M 4/52; H01M 10/0525; H01M 10/0585

(52) U.S. Cl. CPC H01M 4/364; H01M 4/1315; H01M 4/13915; H01M 4/366; H01M 4/382; H01M 4/502; H01M 4/523; H01M 10/0525; H01M 10/0585; H01M 2004/027; H01M 2004/028

(57) ABSTRACT

A lithium-ion battery includes a lithium-free cathode, a lithiated anode, and a separator/electrolyte between the lithium-free cathode and the lithiated anode. The lithium-free cathode includes a composite of FeOF and MnO₂. According to an implementation, the FeOF are in the form of nanorods. According to an implementation, the MnO₂ are in the form of monolayer nanosheets.

### CROSS-REFERENCE TO RELATED APPLICATIONS

This application is a divisional application of U.S. Non-Provisional patent application Ser. No. 17/909,508, filed on Sep. 6, 2022, now U.S. Pat. No. ______, which is a national phase application of and claims priority to International Patent Application No. PCT/US2021/021108, filed on Mar. 5, 2021, which claims priority to U.S. Provisional Patent Application No. 62/986,079, filed on Mar. 6, 2020, the contents of each of which are hereby incorporated by reference in their entirety.

### GOVERNMENT LICENSE RIGHTS

This invention was made with government support under contract no. DE-EE0008236 awarded by the Department of Energy. The government has certain rights in the invention.

### TECHNICAL FIELD

This disclosure relates generally to lithium battery technology, including a lithium-free binary Fe/Mn-based cathode material, lithium batteries assembled in charged state.

### BACKGROUND

Next-generation lithium-ion batteries (LIBs) have to be developed in order to meet the increasing energy storage demands for many important energy-storage applications, including personal electronic devices, electric vehicles, and girds of sustainable energy. Next-generation lithium batteries should have high energy, high power, enhanced safety, good thermal and mechanical stability, and improved cyclability. It is known that performances of LIBs are determined by many components, particularly, the electrode materials. Therefore, it is crucially important to achieve breakthroughs in the search for alternative electrode materials for next-generation LIBs.

The existing commercial cathode material of lithium cobalt oxide (LiCoO₂) has known issues of poor thermal and mechanical stability. In order to avoid charges in the layered structures of LiCoO₂, only half of its theoretical capacity could be practically utilized (~140 mAh/g). Additionally, the decomposition of LiCoO₂ reactions can cause fire. Another issue of LiCoO₂ is the presence of toxic and expensive element Co. The shortage of Co to meet the five-fold increase in demands recently makes Co one of the most expensive elements besides previous metals. Therefore, may efforts are focused on the development of alternative layered cathode materials where Co is replaced or partially replaced.

For example, LiNi_{1-x-y}MnₓCo_{y}O₂ (NMC) and LiNi_{1-x-y}CoₓAl_{y}O₂ (NCA) cathode materials have demonstrated highly improved performances. The partial replacement of Co with Ni, Mn, Al in cathode materials have been successfully commercialized. However, Co is still present.

Next-generation Co-free cathode materials need to be developed. One candidate to replace Co is Mn, which is not only abundant but also environmentally benign. Recently, computational work has pointed out that two-dimensional (2-D) monolayer MnO₂ sheets, which have a high theoretical capacity of 616 mAh/g as well high lithium adsorption energy (4.37 eV) and low lithium diffusion barrier (0.148 eV), in contrast to that of bulk MnO₂, are promising high-energy and high-power cathode materials for next-generation LIBs. Unfortunately, monolayer MnO₂ sheets suffer the issues of restacking and poor stability.

Another promising cathode material is Fe for its abundance and low cost. Fe-based LiFePO₄ has been successfully commercialized, but its capacity is moderate. Another Fe-based candidate FeOF with polar covalent Fe—O bonds in ionic fluoride structure is proposed as high capacity cathode materials. FeOF has an impressively high theoretical capacity of 885 mAh/g. However, it was a challenging task to synthesize battery-grade FeOF. Our group developed a wet-chemical approach to prepare pure FeOF recently. The as-prepared FeOF demonstrated promising performance as cathodes for both sodium- and lithium-ion batteries.

Thus, there is a need to develop improved lithium-ion batteries that address the aforementioned challenges or shortcomings.

### BRIEF DESCRIPTION OF THE DRAWINGS

FIG. 1 is a schematic illustration of a lithium-ion battery.

FIG. 2 is a schematic illustration of the preparation of an FeOF@MnO₂ composite.

FIG. 3A is an FESEM image of 2-D monolayer MnO₂ nanosheets.

FIG. 3B is an FESEM image of 1-D FeOF nanorods.

FIGS. 3C and 3D are FESEM images of an FeOF@MnO₂ composite at a low-magnification view and a high-magnification view, respectively.

FIGS. 4A and 4B are TEM images of an FeOF@MnO₂ composite at a low-magnification view and a high-magnification view, respectively.

FIG. 5A is a graph illustrating a charge-discharge profile of the first three cycles for of a lithium-ion battery with an FeOF@MnO2 composite.

FIG. 5B is a graph illustrating cycling and rate performance of a lithium-ion battery with an FeOF@MnO2 composite and with MnO2.

### DETAILED DESCRIPTION

Referring now to the figures, FIG. 1 is a schematic illustration of a lithium-ion battery (LIB) 10. The LIB 10 may include a first layer of a lithium-free cathode 12, a second separator/electrolyte layer 14, and a third layer of a lithiated/lithium anode 16. The second separator layer 14 generally may separate the lithium-free cathode first layer 12 and the lithiated anode third layer 16 and facilitate Li ion transfer. The lithium-free cathode 12 generally may be a composite cathode including MnO₂ and FeOF. In embodiments, the MnO₂ may be in the form of monolayer nanosheets, and the FeOF may be in the form of nanorods. The FeOF nanorods could be sandwiched or wrapped by the monolayer MnO₂ nanosheets. The second separator layer 14 may be an electrolyte layer. The lithiated anode may include one or more of Li, LiₓSi, Li_{y}C, and Li_{z}M (Note: Li=lithium, Si=silicon, C=carbon, M=metals).

The MnO₂ and FeOF are lithium-free cathode materials and generally cannot be coupled with lithium-free anodes (e.g., graphite or silicon), in contrast to that in existing lithium-ion batteries. All commercial LIBs use cathode materials as the reservoir for lithium and lithium-free carbon and/or silicon as anodes. Commercial LIBs are always assembled in discharged state. In contrast, lithium-free MnO₂ or FeOF can be coupled with lithium metal anodes to make LIBs that are assembled in fully charged state. Beside lithium metal, lithiated silicon anodes, lithiated carbon or lithium metal alloys can also be employed. By using the lithium-free cathodes, the as-assembled LIBs will be tolerant to overcharge, therefore achieving improved safety, in contrast to existing LIBs using cathodes as the lithium sources.

The presence of FeOF nanoparticles could prevent the restacking of the monolayer MnO₂ nanosheets. In other words, the instinct electrochemical properties of monolayer MnO₂ could be preserved. At the same time, the presence of monolayer MnO₂ nanosheets could enhance the electrical integration of the FeOF nanorods. Synergistic effects can lead to novel Fe/Mn-based lithium-free cathode materials with both high voltage and high capacity. As a result, the structured composite can facilitate the reversible storage of lithium.

### Experimental Section

Materials synthesis: All chemicals were used as received. (1) FeOF nanorods were synthesized based on a wet-chemical method. Typically, 66.8 mg of FeF₃·3H₂O was added to 32 mL of 1-Propanol in a 45 mL Teflon chamber. The mixture was sonicated for 10 min and heated to 200° C. for 24 h in an autoclave. The as-synthesized FeOF nanorods were collected and thoroughly washed with deionized water and ethanol and then dried in a vacuum oven for 12 h at 120° C. (2) Single layer δ-MnO₂ nanosheets were synthesized based a modified method. Typically, 0.1 M sodium dodecyl sulfate solution (64 ml) and 0.1 M sulfuric acid of (32 ml) were added into a 500 mL round bottom flask containing 283 mL of DI water and heated to 95° C. KMnO₄ solution (0.05M, 6.4 mL) was rapidly added to flask and the mixture was heated for 60 min. A dark homogenous solution was observed and the reactor was immediately quenched in ice-cold water until it reached room temperature. The as-synthesized monolayer MnO₂ sheets were then similarly collected and thoroughly washed by water and ethanol. (3) The FeOF@MnO₂ composites were then synthesized. Typically, the FeOF nanorods were dispersed in 10 mL of water by alternative sonication and vortex mixing for 30 min. A 10 mL of monolayer δ-MnO₂ sheets dispersed in solution was mixed into the FeOF solution. This mixture was sonicated for 10 min before being transferred into a beaker. The mixture was heated at 35° C. for 24 h along with continuous stirring. The dried sample was collected, and vacuum dried at 120° C. for 24 h.

Material Characterization: Powder X-ray diffraction (XRD) of the samples was carried out in a Rigaku D-MAX/B X-ray powder diffractometer using Cu Kα radiation. The morphologies of the products were characterized by a field emission/scanning electron microscopy (JSM-7600 FESEM, equipped with X-ray energy-dispersive spectrometer (EDS)), by a transmission electron microscopy (JEOL 2010 TEM with accelerating voltage of 200 kV), and by a Shimadzu UV-2600 UV-Vis Spectrophotometer.

Electrochemical Measurements: Electrochemical performances of the as-prepared composite of FeOF@MnO₂ nanorods@nanosheets as lithium-free cathode were preliminarily evaluated. Typically, composite FeOF@MnO₂ nanostructure was investigated using CR2032 coin cells. 80 wt % active materials, 10 wt. % Super P Carbon and 10 wt. % polyvinylidene binder (PVDF) were mixed in an N-methyl-2-pyrrolidone solvent to form a slurry. The slurry was pasted on Al foil and dried in a vacuum oven for 12 h at 120° C. Celgard microporous membrane was used as the separator. 1M LiPF₆ in ethylene carbonate (EC)/diethyl carbonate (DEC) (v/v=1:1) solution was used as electrolyte. The coin cells were assembled in an argon-filled glove box. The assembled cells were tested on a Neware Battery Testing system.

### Results and Discussion

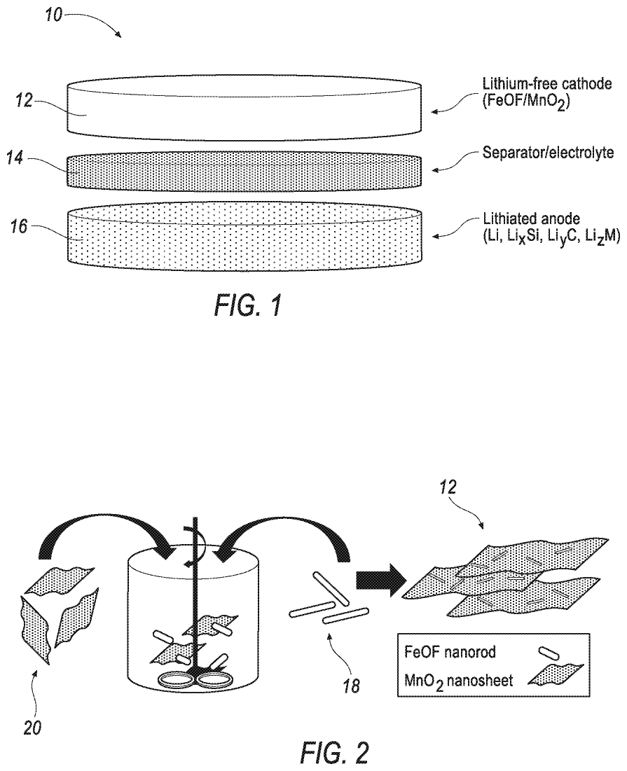

As generally illustrated in FIG. 2, the combination of 1-D FeOF nanorods 18 and 2-D MnO₂ nanosheets 20 may facilitate the formation of a sandwich-like structure. Here, FeOF nanorods 18 may be inserted between MnO₂ nanosheets 20 in order to prevent the restacking of MnO₂ nanosheets. It is known that restacking of MnO₂ nanosheets can lead to the formation of bulk MnO₂ with distinct properties from monolayer MnO₂. Bulk MnO₂ can be used as anode materials for LIBs, but not cathodes. In contrast, monolayer MnO₂ is calculated to exhibit high capacity of 616 mAh/g as cathode materials for LIBs. MnO₂ nanosheets can be well dispersed in solution with a typical absorption peak ~374 nm. The characteristic absorption peak ~374 nm may be assigned to monolayer MnO₂ with thickness of 0.95 nm. The monolayer MnO₂ nanosheets with extremely large exposed surface area can facilitate the aggregation of FeOF nanorods on the surface of nanosheets in order to minimize total energy. At the same time, well dispersed nanorods and nanosheets under continuous stirring can ensure uniform distribution of the two leading the formation of structured FeOF@MnO₂ composite.

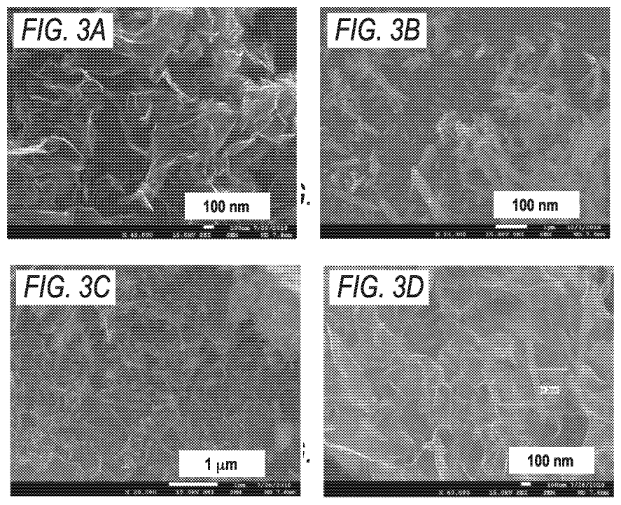

The successful preparation of FeOF@MnO₂ composite was revealed by Field Emission Scanning Electron Microscope (FESEM) characterization, as illustrated in FIGS. 3A-3D. As compared to precursor MnO₂ nanosheets (FIG. 3A), the characteristic wrinkled and folded morphology of monolayer MnO₂ nanosheet was well preserved in the product of FeOF@MnO₂ composite (FIG. 3D). As compared to precursor FeOF nanorods (FIG. 3B), the rod-like morphology was observed though the composite (FIG. 3C). FESEM characterization evidenced that the restacking of MnO₂ nanosheets to form bulk MnO₂ was successfully prevented in the presence of FeOF nanorods. The even distribution of FeOF nanorods in MnO₂ nanosheets was revealed by observed light contrast of nanorods surrounded and wrapped by wrinkled sheets as revealed by the FESEM images (FIGS. 3C and 3D). Although the sizes of nanorods are not uniform, they were wrapped and covered by 2-D MnO₂ nanosheets which prevent their aggregation. A large FeOF nanorod with width of 84 nm covered with flexible light contrast monolayer MnO₂ nanosheet is highlighted in FIG. 3D. Even distribution of FeOF nanorods in MnO₂ nanosheets was also evidenced by elemental mapping analysis. EDS analysis show the atomic ration of Fe:Mn at 25:11.

The FeOF@MnO₂ composite was further characterized by transmission electron microscopy (TEM), as illustrated in FIGS. 4A and 4B. The FeOF rods have length of few hundreds nanometers and width of few tens nanometers. The width of FeOF nanorods is much larger than the thickness of MnO₂ nanosheet at ~1 nm. Therefore, under TEM observation, the contrast of FeOF nanorods is darker than those MnO₂ nanosheets which help to easily distinguish them. It should be noted that the wrinkles of folded MnO₂ nanosheets also showed dark contrast but narrower and darker as compared to that of FeOF nanorods (as seen in FIG. 4A). The formation of wrinkles instead of aggregated bulk MnO₂ layers in the presence of FeOF nanorods suggests that FeOF nanorods functioned as pillars inserted between those monolayer MnO₂ nanosheets (FIG. 4B). The FeOF@MnO₂ composite can offer electrical integration and advantages of both 1-D and 2-D materials. In other words, the composite offers open structures exposed to liquid electrolyte and can facilitate the reversible storage of lithium.

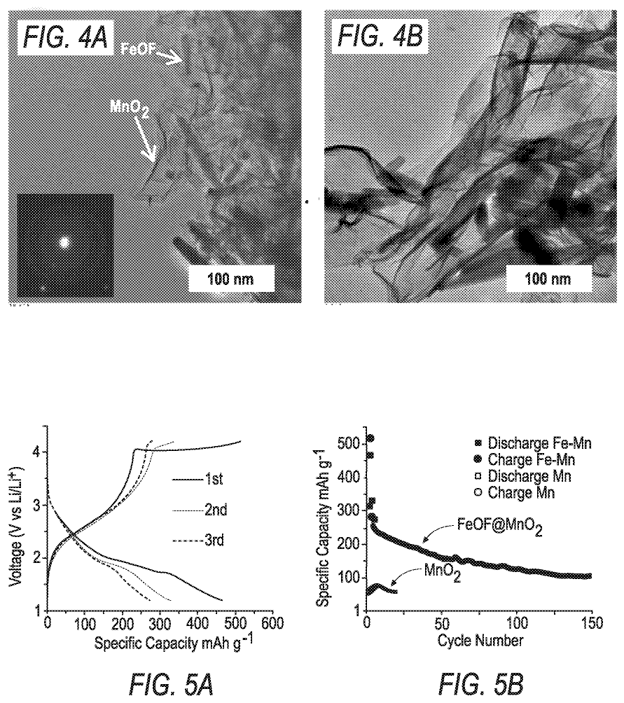

As generally illustrated in FIGS. 5A and 5B, electrochemical performance of the as-prepared FeOF@MnO₂ composite as cathodes in lithium-ion batteries was evaluated. For the purposes of this analysis, lithium metal was used as an anode in order to simplify the electrochemical analysis. The first three cycles of the charge-discharge profile are illustrated in FIG. 5A. Test conditions used were currents of 100 mA/g and a voltage window of 1.2-4.2 V. The open-circuit voltage is about 3.2V. It is known that electrodes based on monolayer MnO₂ nanosheets exfoliated from layered MnO₂ have open-circuit voltage about 3.5V. Electrodes based on FeOF synthesized by the roll-quenching method have open-circuit voltage about 3.2V. The open-circuit voltage of composite electrodes is in the range determined by chemical potential of the active materials. In the first discharge (lithiation) slope, the small plateau around 3V should be assigned to the redox reaction of Mn³⁺/Mn⁴⁺ couple. The plateau around 2V to 1.6V should be assigned to the insertion of Li ions into FeOF. The slop/plateau approximately 1.0 V could be attributed to the partial formation of LiF, Li₂O, and metallic Fe similar to those observed in sodium ion batteries. The first cycle discharge delivered a capacity of 468 mAh/g (as seen in FIG. 5A). This number is smaller than that of theoretical values for monolayer MnO₂ nanosheets at 616 mAh/g or FeOF at 885 mAh/g. This indicated no full lithiation was achieved in first cycle discharge. Although the not optimized capacity is significantly higher than standard cathode of LiCoO₂ at 140 mAh/g, further process optimization is needed to increase the degree of lithiation. It should be noted that the testing current of 100 mA/g is moderately high for the evaluation of cathode materials which might affect the full utilization of active materials.

First cycle charge delivered a capacity of 540 mAh/g (as seen in FIG. 5A). The observed differences in first cycle charge and discharge capacity for cathode materials may be attributed accidental partial discharge in cell assembly process before testing as the cells were assembled in charged state. In other words, first cycle discharge capacity was not fully recorded by the battery testers. The partial discharge before testing was also evidenced by the relatively smaller open circuit voltage of 3.2 V measured than estimated based on chemical potentials. Another possible cause may be that electrochemical parasitic reactions associated with electrolyte decompositions and corrosion of aluminum current collector and even the stainless steel case under high voltage conditions. The plateau around 4V could be associated with those parasitic reactions (as seen in FIG. 5A). The reduction in 4V plateau capacities from 1^{st}, 2^{nd} to 3^{rd} suggested that those parasitic reactions reduced dramatically. The parasitic reactions were decremented due to the formation of stable liquid-solid interfaces/interphases.

As compared to control electrodes of monolayer MnO₂ nanosheets, the composite FeOF@MnO₂ electrode demonstrated higher capacity and better cyclability than that of control of monolayer MnO₂ nanosheets (as seen in FIG. 5B). From 3^{rd} cycle onward, the FeOF@MnO₂ cathodes demonstrated reasonable capacity retention and stability. The cathode can be cycled for at least 150 times with a capacity comparable to standard cathode of LiCoO₂ cathodes.

Further, rate performance was tested. The specific capacity can be maintained at above 150 mAh/g at rate of 100 mA/g for 40 cycles. When the testing current was doubled to 200 mA/g, capacity dropped moderately. The result suggests that this cathode have potential for high rate batteries.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of medical imaging, it should be appreciated that the present techniques are not limited to such medical contexts. The provision of examples and explanations in such a medical context is to facilitate explanation by providing instances of implementations and applications. The disclosed approaches may also be utilized in other contexts, such as the non-destructive inspection of manufactured parts or goods (i.e., quality control or quality review applications), and/or the non-invasive inspection or imaging techniques.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A lithium-ion battery comprising:
a lithium-free cathode;
a lithiated anode; and
a separator between the lithium-free cathode and the lithiated anode.

2. The lithium-ion battery of claim 1, wherein the lithium-free cathode includes a composite of FeOF and MnO₂.

3. The lithium-ion battery of claim 2, wherein the FeOF comprises FeOF nanorods.

4. The lithium-ion battery of claim 2, wherein the MnO₂ comprises monolayer MnO₂ nanosheets.

5. The lithium-ion battery of claim 2, wherein the FeOF comprises FeOF nanorods, and the MnO₂ comprises MnO₂ monolayer nanosheets.

6. The lithium-ion battery of claim 5, wherein the FeOF nanorods are sandwiched between or wrapped by the monolayer MnO₂ nanosheets.

7. The lithium-ion battery of claim 5, wherein the FeOF nanorods are evenly distributed on the monolayer MnO₂ nanosheets.

8. The lithium-ion battery of claim 1, wherein:
the separator is an electrolyte, or
the separator comprises a microporous membrane.

9. The lithium-ion battery of claim 1, wherein the lithiated anode includes at least one of Li, LiₓSi, Li_{y}C, and Li_{z}M.

10. The lithium-ion battery of claim 1, wherein the lithium-ion battery is assembled in a fully charged state.

11. The lithium-ion battery of claim 1, further comprising an electrolyte, wherein the electrolyte includes 1 M LiPF6 in ethylene carbonate (EC)/diethyl carbonate (DEC) (v/v=1:1).

12. A composite for a lithium-ion battery, comprising:
FeOF nanorods; and
monolayer MnO₂ nanosheets;
wherein the FeOF nanorods are sandwiched between or wrapped by the monolayer MnO₂ nanosheets.

13. The composite of claim 12, wherein the composite is in the form of a cathode of the lithium-ion battery.

14. A lithium-ion battery, comprising:
a lithium-free cathode;
a separator and/or an electrolyte; and
a lithiated anode;
wherein the lithium-free cathode includes a composite of FeOF and MnO₂.

15. The lithium-ion battery of claim 14, wherein the FeOF comprises FeOF nanorods.

16. The lithium-ion battery of claim 14, wherein the MnO₂ comprises monolayer MnO₂ nanosheets.

17. The lithium-ion battery of claim 16, wherein the FeOF comprises FeOF nanorods sandwiched between or wrapped by the monolayer MnO₂ nanosheets.

18. The lithium-ion battery of claim 14, wherein the lithiated anode includes at least one of Li, LiₓSi, Li_{y}C, and Li_{z}M.

19. The lithium-ion battery of claim 14, wherein the lithium-ion battery is assembled in a fully charged state.

20. The lithium-ion battery of claim 14, wherein the separator comprises a microporous membrane and/or the electrolyte includes 1 M LiPF6 in ethylene carbonate (EC)/diethyl carbonate (DEC) (v/v=1:1).
